(19) United States
(12) Patent Application Publication
(10) Pub. No.: US 2015/0336730 A1
(43) Pub. Date: Nov. 26, 2015

(54) PAPER-BASED THERMAL INSULATED CONTAINER AND METHOD OF MANUFACTURING THE SAME

(71) Applicant: Douglas Arthur Shields, Hagerstown, MD (US)

(72) Inventor: Douglas Arthur Shields, Hagerstown, MD (US)

(21) Appl. No.: 14/715,870

(22) Filed: May 19, 2015

Related U.S. Application Data
(60) Provisional application No. 62/000,884, filed on May 20, 2014.

(51) Int. Cl. B65D 81/18; B31B 7/26; B65D 5/62; B65D 5/30; B65D 5/56

(52) U.S. Cl. CPC B65D 81/18; B65D 5/302; B65D 5/56; B65D 5/62; B31B 7/26

(57) ABSTRACT

A thermal insulating container and a method of making the same is provided. The thermal insulating container may include a folded carton and a cooperating lid pivotably connected thereto by a living hinge. The thermal insulating container may be deployed by folding a flat configuration container cut-out into a three-dimensional configuration, forming the thermal insulated container. The container cutout may be die-cut from a unitary construction material formed by adhering together a paper-based interior layer, a paper-based intermediate layer and a paper-based exterior layer. The interior and intermediate layer may be coated with water-resistant coating. The paperboard outside liner may be treated with a UV-coating as well as provided with predetermined graphic printing.

### CROSS-REFERENCE TO RELATED APPLICATION

This application claims the benefit of priority of U.S. provisional application No. 62/000,884, 20 May 2014, the contents of which are herein incorporated by reference.

### BACKGROUND OF THE INVENTION

The present invention relates to portable coolers and, more particularly, a foldable thermal insulated container made from paper-based material.

Conventional portable coolers are expanded polystyrene (EPS) ice chests. Though EPS is recyclable, the economies of recycling polystyrene are not sound. Moreover, EPS is not compostable. EPS also has the disadvantage of being very brittle and easily broken or damaged. Typically, EPS ice chests have a lid that is a separate piece, and so more likely to be misplaced or damage. Also, ESP cannot be printed with unique, multi-color messaging.

As can be seen, there is a need for portable coolers made from a paper-based material so as to be predictably recyclable, repulpable and compostable, as well as receptive to a variety of graphic printing and the formation of living hinges, yet affords sufficient thermal insulation for its contents.

### SUMMARY OF THE INVENTION

In one aspect of the present invention, a method of forming a reusable, recyclable, foldable thermal insulating container cut-out from a unitary construction includes providing a planar interior layer made of paper-based material; providing a planar intermediate layer made of paper-based material; treating the interior layer with a water resistant coating; bonding the interior layer to the intermediate layer using a water-resistant adhesive; bonding a planar exterior layer made of paper-based material to the intermediate layer, sandwiching the intermediate layer between the interior layer so as to form a flat configuration of unitary construction; and forming a predetermined container cut-out from the unitary construction.

In another aspect of the present invention, a method of forming a reusable, recyclable, foldable thermal insulating container cut-out from a unitary construction, includes providing a planar interior layer made of paper-based material; providing a planar intermediate layer made of paper-based material; providing a planar exterior layer made of paper-based material; treating the interior layer with a water resistant coating; treating the intermediate layer with a water resistant coating; applying a graphic printing to the exterior layer prior to the treatment of the UV coating; treating the exterior layer with a UV coating; bonding the interior layer to the intermediate layer using a water-resistant adhesive; bonding the planar exterior layer made of paper-based material to the intermediate layer, forming a flat configuration of unitary construction; forming a predetermined container cut-out from the unitary construction; forming a first living hinge along the container cut-out so as to define a carton portion and a lid portion of the container cut-out; forming a plurality of living hinge so as to define a plurality of side panels; forming a plurality of living hinge so as to define a plurality of folding corners; forming complementary portions of one complete handle in two adjacent fold corners; forming a first latch portion and an opposing second latch portion in the container cut-out; and folding along the plurality of living hinges to form a three-dimensional configuration of the thermal insulating container.

In yet another aspect of the present invention, a reusable, recyclable, foldable thermal insulating container having a first flat configuration and a second three-dimensional configuration includes an interior, intermediate, and exterior layer bonded together by a water-resistant adhesive, wherein each layer is a planar paper-based material; a water-resistant coating applied to the interior and intermediate layers; a UV coating applied to the exterior layer; a plurality of living hinges defining a plurality of panels and folding corners so as to be foldable into the three-dimensional configuration; and a first living hinge defining a lid from at least one of the panels.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown use;

FIG. 2 is a perspective view of an exemplary embodiment of the present invention, shown use;

FIG. 3 is a section view of an exemplary embodiment of the present invention, taken along line 3-3 in FIG. 1;

FIG. 4 is an enlarged section view of an exemplary embodiment of the present invention of a portion of FIG. 3;

FIG. 5 is a section view of an exemplary embodiment of the present invention, taken along line 5-5 in FIG. 3;

FIG. 6 is a top view of an exemplary embodiment of the present invention;

FIG. 7 is a top view of an exemplary embodiment of the present invention;

FIG. 8 is a top view of an exemplary embodiment of the present invention;

FIG. 9 is a top view of an exemplary embodiment of the present invention;

FIG. 10 is a top view of an exemplary embodiment of the present invention; and

FIG. 11 is a top view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a thermal insulating container and a method of making the same. The thermal insulating container may include a folded carton and a cooperating lid pivotably connected thereto by a living hinge. The thermal insulating container may be deployed by folding a flat configuration container cut-out into a three-dimensional configuration, forming the thermal insulated container. The container cutout may be die-cut from a unitary construction material formed by adhering together a paper-based interior layer, a paper-based intermediate layer and a paper-based exterior layer. The interior and intermediate layer may be coated with water-resistant coating. The paperboard outside liner may be treated with a UV-coating as well as provided with predetermined graphic printing.

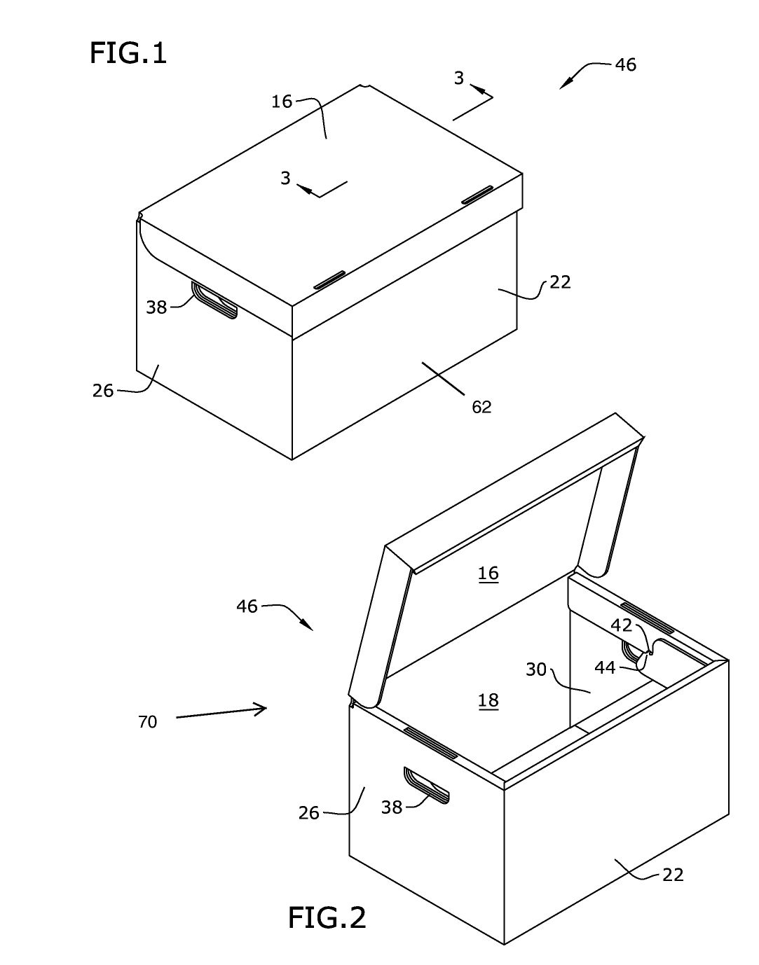

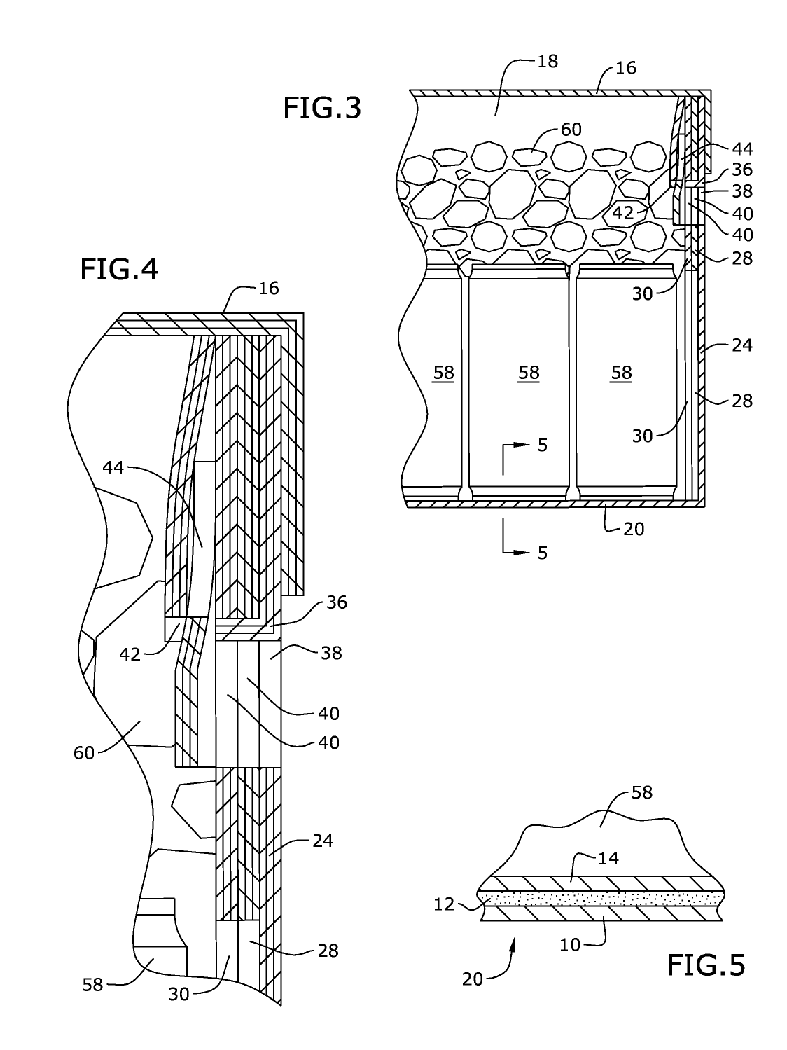

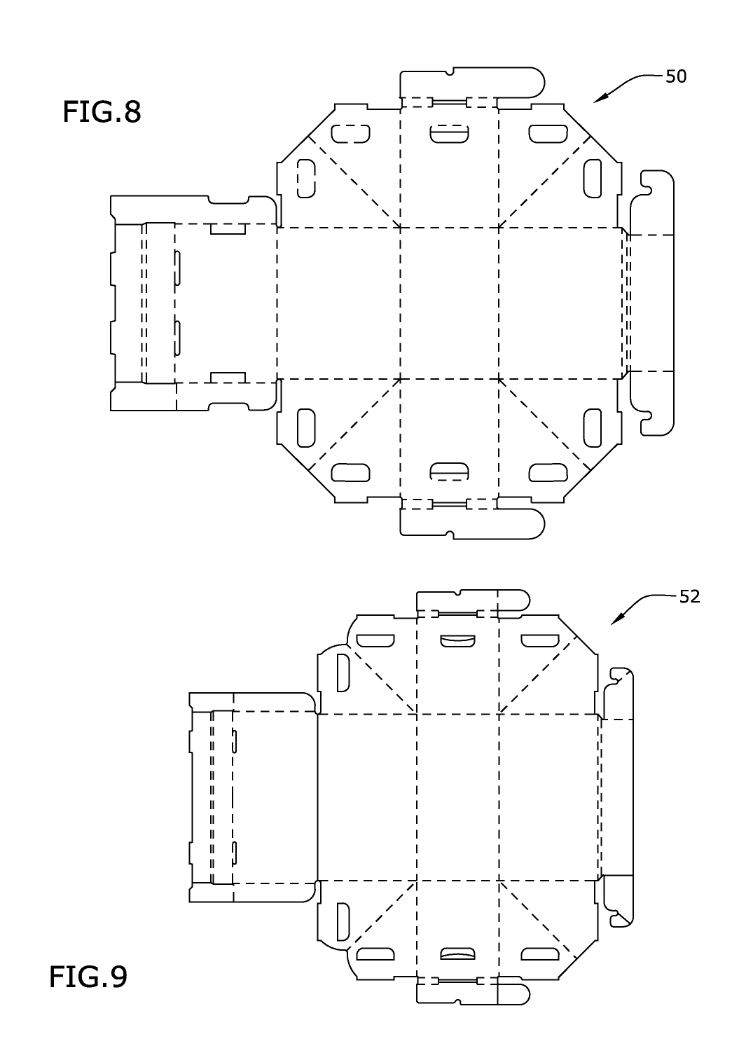

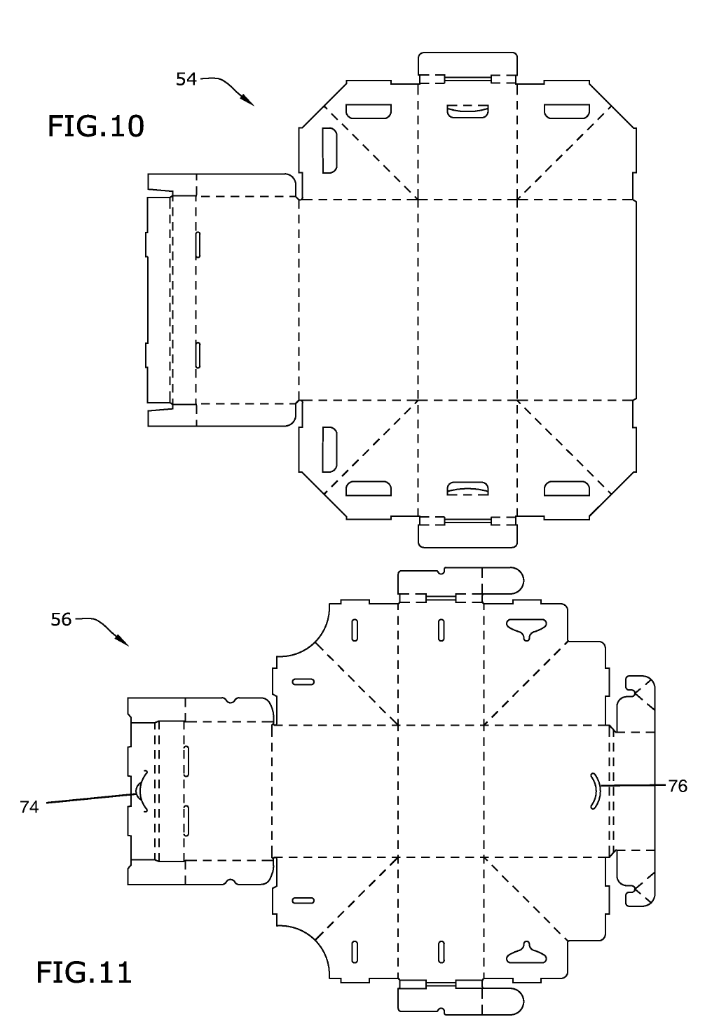

Referring to FIGS. 1 through 11, the present invention may include a paper-based thermal insulating container 70, and a method of making the same. The thermal insulating container 70 may include a carton 62 pivotably connected to a cooperating lid 16 by a living hinge 72. The carton 62 may be deployed by folding a flat configuration predetermined container cut-out 46, 48, 50, 52, 54 or 56 into a three-dimensional configuration, forming the thermal insulated container 70. Each predetermined container cut-out 46, 48, 50, 52, 54 or 56 may be formed from a unitary construction. The unitary construction may be formed by the combination of an interior layer 14, an intermediate layer 12, and an exterior layer 10.

Each layer 10, 12, 14 may be made of paper-based material including, but not limited to paperboard, kraft paperboard, cardboard, boxboard, pulp and the like so as to be capable of being scored and bent without fracture. The paper-based material may form flutes or be partially formed into flutes. The interior layer 14 and the intermediate layer 12 may be treated with a water-resistant coating so as to be water resistant. The exterior layer 10 may be treated with a UV coating or other surface treatments which either are cured by ultraviolet radiation, or protect the underlying material from the harmful effects of ultraviolet radiation. In certain embodiments, a graphic printing or other visual communication may be printed on the paper-based exterior layer 10 prior to the application of the protective UV coating.

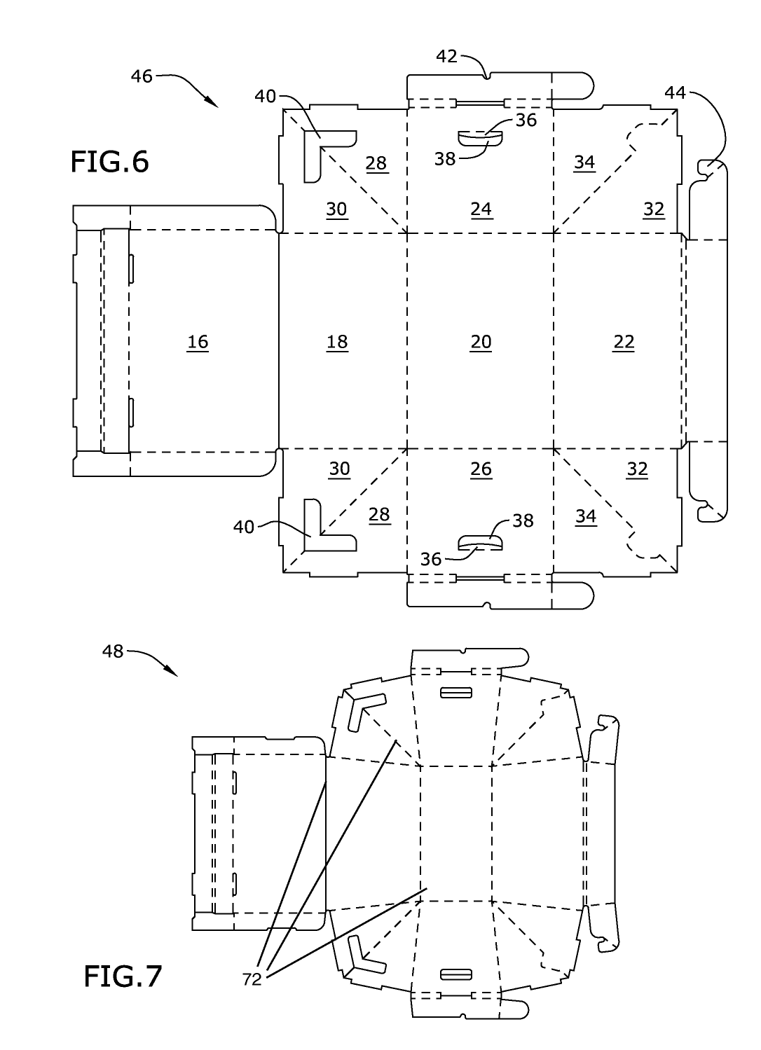

Each container cut-out may be scored so as to fold about living hinges 72 from the flat configuration to the three-dimensional configuration. Living hinges 72, may be folds, creases, perforations or the like facilitating the paper-based material to bend without fracturing. Referring to FIGS. 6 through 11, the living hinges 72 may define two generally triangular fold corners 34, 32 or two generally triangular handle fold corners 30, 28, which form portions of a complete handle 40. The living hinges 72 may also define generally rectangular side panels 18, 20, 22, 24, 26. Some side panels 24, 26 may form handle openings 38 and handle bends 36. The living hinges 72 may also define the cooperative lid 16 from one of the rear panel 18. The living hinges 72 may also define the locking panels 42 and 44 from respective side panels 24, 26 and the front panel 22, respectively.

The container cut-out 56 may form a first latch portion 74 and an opposing second latch portion 76, each dimensioned and adapted to mate in the three-dimensional configurations so as to prevent the lid 16 from pivoting about its living hinge 72.

The method of making the present invention may include the following. A water-resistant coating may be applied to the interior layer 14 and the intermediate layer 12. Then the interior layer 14 may be bonded to the intermediate layer 12 using water-resistant adhesives. Then graphic printing may be applied to the exterior layer 10. Then UV coating may be applied to the exterior layer 10. Then the exterior layer 10 may be bonded to the combined interior-intermediate layers 14-12 using water-resistant adhesives, forming the unitary construction. A predetermined container cut-out out 46, 48, 50, 52, 54 or 56, as illustrated in FIGS. 6 through 11, may be formed by die-cutting or the like. The living hinges 72 may be scored into the predetermined container cut-out so as to define a plurality of panels and triangular folding corners. Handle openings 38, 40 and/or latch portions 74, 76 may be formed into the predetermined container cut-out. Then the predetermined container cut-out may be folded about the living hinges 72 from the flat configuration and into the three-dimensional configuration, forming the thermal insulated container 70.

After filling with ice 60, the resulting thermal insulated container 70 may be used to keep its contents 58 cool by closing the lid 16 onto the carton 62. Subsequent to use, the thermal insulated container 70 may be readably recycled, repulped, composted or the like.

It should be understood, of course, that the foregoing relates to exemplary embodiments of the invention and that modifications may be made without departing from the spirit and scope of the invention as set forth in the following claims.

What is claimed is:

1. A method of forming a reusable, recyclable, foldable thermal insulating container cut-out from a unitary construction, comprising:
providing a planar interior layer made of paper-based material;
providing a planar intermediate layer made of paper-based material;
treating the interior layer with a water resistant coating;
bonding the interior layer to the intermediate layer using a water-resistant adhesive;
bonding a planar exterior layer made of paper-based material to the intermediate layer, sandwiching the intermediate layer between the interior layer so as to form a flat configuration of unitary construction; and
forming a predetermined container cut-out from the unitary construction.

2. The method of claim 1, further including treating the intermediate layer with a water resistant coating.

3. The method of claim 1, further comprising treating the exterior layer with a UV coating.

4. The method of claim 3, further comprising applying a graphic printing to the exterior layer prior to the treatment of the UV coating.

5. The method of claim 1, forming a first living hinge along the container cut-out so as to define a carton portion and a lid portion of the container cut-out.

6. The method of claim 1, forming a plurality of living hinge so as to define a plurality of side panels.

7. The method of claim 6, forming a plurality of living hinge so as to define a plurality of folding corners.

8. The method of claim 7, further comprising forming complementary portions of one complete handle in two adjacent fold corners.

9. The method of claim 1, further comprising forming a first latch portion and an opposing second latch portion in the container cut-out.

10. The method of claim 1, folding along the plurality of living hinges to form a three-dimensional configuration of the thermal insulating container.

11. A method of forming a reusable, recyclable, foldable thermal insulating container cut-out from a unitary construction, comprising:
providing a planar interior layer made of paper-based material;
providing a planar intermediate layer made of paper-based material;
providing a planar exterior layer made of paper-based material;
treating the interior layer with a water resistant coating;
treating the intermediate layer with a water resistant coating;
applying a graphic printing to the exterior layer prior to the treatment of the UV coating;
treating the exterior layer with a UV coating.
bonding the interior layer to the intermediate layer using a water-resistant adhesive;
bonding the planar exterior layer made of paper-based material to the intermediate layer, forming a flat configuration of unitary construction;
forming a predetermined container cut-out from the unitary construction;
forming a first living hinge along the container cut-out so as to define a carton portion and a lid portion of the container cut-out;
forming a plurality of living hinge so as to define a plurality of side panels;
forming a plurality of living hinge so as to define a plurality of folding corners;
forming complementary portions of one complete handle in two adjacent fold corners;
forming a first latch portion and an opposing second latch portion in the container cut-out; and
folding along the plurality of living hinges to form a three-dimensional configuration of the thermal insulating container.

12. A reusable, recyclable, foldable thermal insulating container having a first flat configuration and a second three-dimensional configuration, comprising:
an interior, intermediate, and exterior layer bonded together by a water-resistant adhesive, wherein each layer is a planar paper-based material;
a water-resistant coating applied to the interior and intermediate layer;
a UV coating applied to the exterior layer;
a plurality of living hinges defining a plurality of panels and folding corners so as to be foldable into the three-dimensional configuration; and
a first living hinge defining a lid from at least one of the panels.

13. The thermal insulating container of claim 12, further comprising graphic printing applied to the exterior layer.

14. The thermal insulating container of claim 12, further comprising complementary handle portions formed by the flat configuration.

15. The thermal insulating container of claim 12, further comprising complementary latch portions formed by the flat configuration.
